(19) United States
(12) Patent Application Publication
(10) Pub. No.: US 2026/0133617 A1
(43) Pub. Date: May 14, 2026

(54) POWER AND PERFORMANCE MANAGEMENT OF PERIPHERAL COMPONENT INTERCONNECT EXPRESS DEVICES

(71) Applicant: QUALCOMM Incorporated, San Diego, CA (US)

(72) Inventors: Srinivas Rao LENGAMANENI, Hyderabad (IN); Bharath Kumar ARCADU, Bangalore (IN)

(21) Appl. No.: 18/946,545

(22) Filed: Nov. 13, 2024

(51) Int. Cl. G06F 1/3234; G06F 1/26; G06F 1/3215

(52) U.S. Cl. CPC G06F 1/325; G06F 1/266; G06F 1/3215

(57) ABSTRACT

Aspects of the disclosure provide apparatuses and techniques for configuring system resources based on a configurable timeout of a wired communication link (e.g., peripheral component interconnect express (PCIe) link) in a standby mode to balance power and performance of the system. The configurable timeout can be based on a predicted link idle time.

### TECHNICAL FIELD

The technology discussed below relates generally to peripheral component interconnect express (PCIe) devices, and more particularly, to techniques for managing power and performance of PCIe devices.

### INTRODUCTION

High-speed interfaces are frequently used between circuits and components of mobile wireless devices and other complex systems. For example, certain devices may include processing, communications, storage, and/or display devices that interact with one another through one or more high-speed interfaces. Some of these devices, including synchronous dynamic random-access memory (SDRAM), may be capable of providing or consuming data and control information at processor clock rates. Other devices, e.g., data storage (e.g., NAND Flash memory), display controllers, and local network interfaces (e.g., WiFi interface) may use variable amounts of data at relatively low video refresh rates.

The peripheral component interconnect express (PCIe) standard is a high-speed interface that supports a high-speed data link capable of transmitting data at multiple gigabits per second. The PCIe interface also has multiple standby modes that can be used when a link is inactive or idle. A PCIe link can provide lower latency and higher data transfer rates compared to parallel buses. A PCIe link can be used for communication between a wide range of different devices. Typically, one device, e.g., a processor or hub, acts as a host, that communicates with multiple devices, referred to as endpoints, through one or more PCIe links. For example, the peripheral devices or components may include graphics adapter cards, network interface cards (NICs), storage accelerator devices, mass storage devices, Input/Output (I/O) interfaces, and other high-performance peripherals.

### BRIEF SUMMARY

The following presents a summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

Aspects of the disclosure provide apparatuses and techniques for configuring system resources based on a configurable timeout of a wired communication link (e.g., peripheral component interconnect express (PCIe) link) in a standby mode to balance power and performance of the system. The configurable timeout can be based on a predicted link idle time.

In one example an apparatus having an interface circuit and a controller is disclosed for a wired data link (e.g., a peripheral component interconnect express (PCIe) link) connected with a link partner. The apparatus includes an interface circuit configured to provide an interface with the wired data link and a controller. The controller is further configured to detect a transition of the wired data link from an active state to a standby state; initiate a timeout period in response to the transition of the wired data link to the standby state, the timeout period being determined based on a predicted link idle time of the wired data link; and configure system resources in response to an expiration of the timeout period with the wired data link remained in the standby state.

In one example, a method of operating an apparatus for data communication is disclosed. The method includes: detecting a transition of a wired data link from an active state to a standby state; initiating a timeout period in response to the transition of the wired data link to the standby state, the timeout period being determined based on a predicted link idle time of the wired data link; and configuring system resources in response to an expiration of the timeout period with the wired data link remained in the standby state.

In one example, an apparatus for data communication is provided. The apparatus includes: means for detecting a transition of a wired data link from an active state to a standby state; means for initiating a timeout period in response to the transition of the wired data link to the standby state, the timeout period being determined based on a predicted link idle time of the wired data link; and means for configuring system resources in response to an expiration of the timeout period with the wired data link remained in the standby state.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the described implementations are intended to include all such aspects and their equivalents.

### BRIEF DESCRIPTION OF THE DRAWINGS

FIG. 1 is a block diagram of a computing architecture with peripheral component interconnect express (PCIe) interfaces suitable for aspects of the present disclosure.

FIG. 2 is a block diagram of a system including a host system and an endpoint device system according to aspects of the present disclosure.

FIG. 3 is a diagram illustrating a process of operating a wired data link between an active state and a standby state using a dynamically predicted link idle time according to some aspects of the disclosure.

FIG. 4 is a flow chart illustrating a process of configuring a PCIe standby timeout according to some aspects of the disclosure.

FIG. 5 is a flow chart illustrating a process of predicting a link idle time of a data link according to some aspects of the disclosure.

FIG. 6 is a flow chart illustrating a process of configuring a timeout period based on a predicted a link idle time according to some aspects of the disclosure.

FIG. 7 is a block diagram of a PCIe link interface processing circuit according to aspects of the present disclosure.

FIG. 8 is a flow diagram of a first exemplary method for controlling system resources based on a predicted link idle time according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, these concepts may be practiced without these specific details. In some instances, well-known structures and components are shown in block diagram form in order to avoid obscuring such concepts.

Aspects of the disclosure provide apparatuses and techniques for configuring system resources based on a configurable timeout of a wired communication link (e.g., peripheral component interconnect express (PCIe) link) in a standby mode to balance power and performance of the system. The configurable timeout can be based on a predicted link idle time.

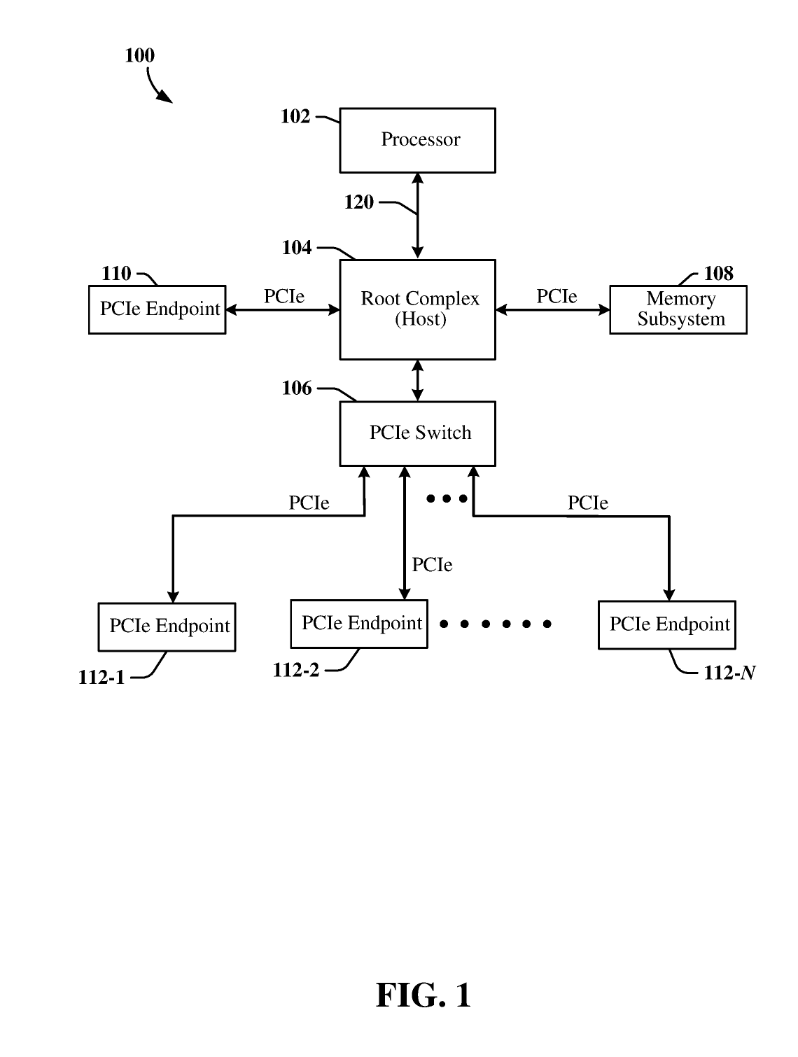

FIG. 1 is a block diagram of an exemplary computing architecture using PCIe interfaces. The computing architecture 100 operates using multiple high-speed PCIe interface serial links. In some aspects, the computing architecture 100 can be implemented in a system-on-chip (SoC). A PCIe interface may be characterized as an apparatus including a point-to-point topology, where separate serial links connect each device to a host, which can be referred to as a root complex 104. In the computing architecture 100, the root complex 104 couples a processor 102 to memory devices, e.g., the memory subsystem 108, and a PCIe switch circuit 106. In some instances, the PCIe switch circuit 106 includes cascaded switch devices. One or more PCIe endpoint devices 110 may be coupled directly to the root complex 104, while other PCIe endpoint devices 112-1, 112-2,… and 112-N may be coupled to the root complex 104 through the PCIe switch circuit 106. The root complex 104 may be coupled to the processor 102 using a bus interface 120 (e.g., a proprietary local bus interface or a standards defined local bus interface). The root complex 104 may control configuration and data transactions through the PCIe interfaces and may generate transaction requests for the processor 102. In some examples, the root complex 104 is implemented in the same integrated circuit (IC) device that includes the processor 102. The root complex 104 can support multiple PCIe ports. In some examples, the processor 102 may include one or more processors (e.g., graphical processing unit (GPU), central processing unit (CPU), neural processing unit (NPU), etc.).

The root complex 104 may control communication between the processor 102 and the memory subsystem 108 which is one example of an endpoint. The memory subsystem 108 can include one or more memories. The root complex 104 (host) also controls communication between the processor 102 and other PCIe endpoint devices (e.g., peripherals) 110, 112-1, 112-2,… 112-N. The PCIe interface may support full-duplex communication between any two endpoints, with no inherent limitation on concurrent access across multiple endpoints. Data packets may carry information through any PCIe link. In a multi-lane PCIe link, packet data may be striped across multiple lanes. The number of lanes in the multi-lane link may be negotiated during device initialization and may be different for different endpoints. When one or both traffic directions of the lanes of the PCIe links are being underutilized by low bandwidth applications that could be adequately served by fewer lanes, then the root complex 104 and endpoint may operate the link with more or fewer transmit lines and receive lines in one or both directions.

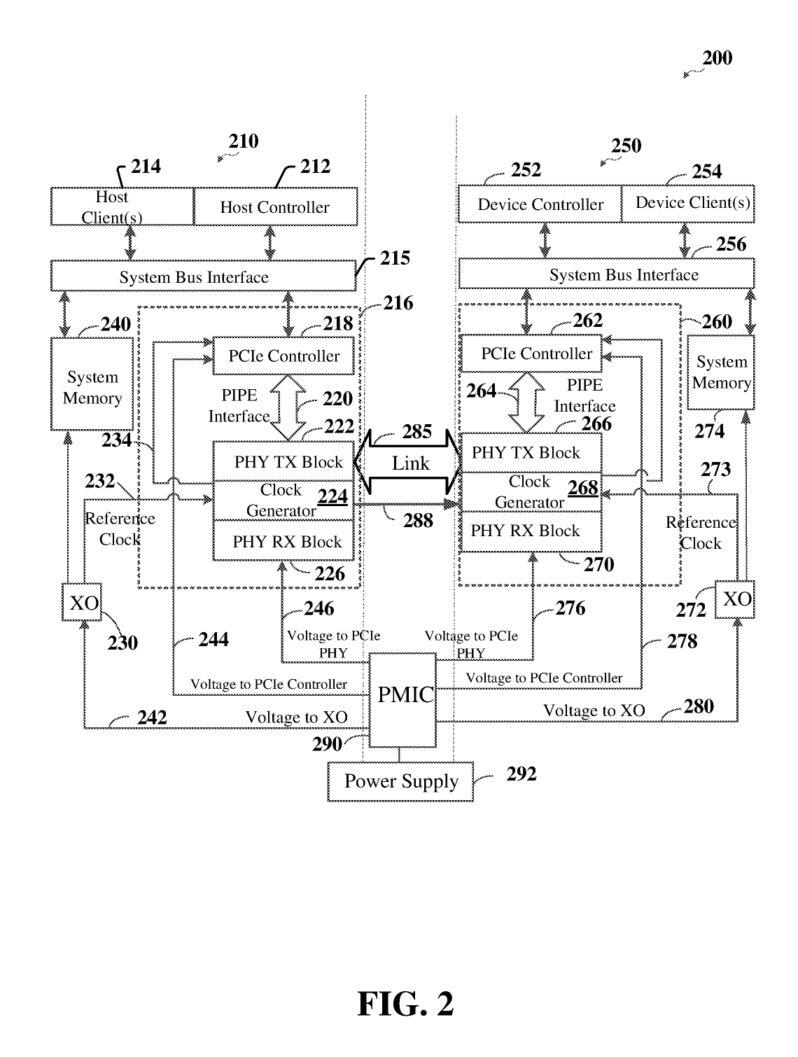

FIG. 2 is a block diagram of an exemplary PCIe system 200 in which aspects of the present disclosure may be implemented. The system 200 includes a host system 210 and an endpoint device system 250, which may be the same as the host and endpoints of FIG. 1. In some aspects, the host system 210 may be integrated on a first chip (e.g., SoC), and the endpoint device system 250 may be integrated on a second chip. In some examples, the host system 210 and the endpoint device system 250 can be included in the same SoC. Alternatively, the host system and/or endpoint device system may be integrated in first and second packages, e.g., system in Package (SiP), first and second system boards with multiple chips, or in other hardware or any combination. In this example, the host system 210 and the endpoint device system 250 are coupled by a PCIe link 285.

The host system 210 includes one or more host clients 214. Each of the one or more host clients 214 may be implemented on a processor executing software that performs the functions of the host clients 214 discussed herein. For the example of more than one host client, the host clients may be implemented on the same processor or different processors. The host system 210 also includes a host controller 212, which may perform root complex functions. The host controller 212 may be implemented on one or more processors executing software that performs the functions of the host controller 212 discussed herein.

The host system 210 includes a PCIe interface circuit 216, a system bus interface 215, and a host system memory 240. The system bus interface 215 may interface the one or more host clients 214 with the host controller 212, and interface each of the one or more host clients 214 and the host controller 212 with the PCIe interface circuit 216 and the host system memory 240. The host system memory 240 can include one or more memories. The PCIe interface circuit 216 provides the host system 210 with an interface to the PCIe link 285. In this regard, the PCIe interface circuit 216 is configured to transmit data (e.g., from the host clients 214) to the endpoint device system 250 over the PCIe link 285 and receive data from the endpoint device system 250 via the PCIe link 285. The PCIe interface circuit 216 includes a PCIe controller 218, a physical interface for PCI Express (PIPE) interface 220, a physical (PHY) transmit (TX) block 222, a clock generator 224, and a PHY receive (RX) block 226. The PIPE interface 220 provides a parallel interface between the PCIe controller 218 and the PHY TX block 222 and the PHY RX block 226. The PCIe controller 218 (which may be implemented in hardware) may be configured to perform transaction layer, data link layer, and flow control functions (e.g., flow control based on PCIe specification).

The host system 210 also includes an oscillator (e.g., crystal oscillator or “XO”) 230 configured to generate a reference clock signal 232. The reference clock signal 232 may have a frequency of 19.2 MHz in one example, but is not limited to such frequency. The reference clock signal 232 is input to the clock generator 224 which generates multiple clock signals based on the reference clock signal 232. In this regard, the clock generator 224 may include a phase locked loop (PLL) or multiple PLLs, in which each PLL generates a respective one of the multiple clock signals by multiplying up the frequency of the reference clock signal 232.

The endpoint device system 250 includes one or more device clients 254. Each device client 254 may be implemented on a processor executing software that performs the functions of the device client 254 discussed herein. For the example of more than one device client 254, the device clients 254 may be implemented on the same processor or different processors. The endpoint device system 250 also includes a device controller 252. The device controller 252 may be configured to receive bandwidth request(s) from one or more device clients, and determine whether to change the number of transmit lines or the number of receive lines based on bandwidth requests. The device controller 252 may be implemented on one or more processors executing software that performs the functions of the device controller.

The endpoint device system 250 includes a PCIe interface circuit 260, a system bus interface 256, and endpoint system memory 274. The system bus interface 256 may interface the one or more device clients 254 with the device controller 252, and interface each of the one or more device clients 254 and device controllers 252 with the PCIe interface circuit 260 and the endpoint system memory 274. The PCIe interface circuit 260 provides the endpoint device system 250 with an interface to the PCIe link 285. In this regard, the PCIe interface circuit 260 is configured to transmit data (e.g., from the device client 254) to the host system 210 (also referred to as the host device) over the PCIe link 285 and receive data from the host system 210 via the PCIe link 285. The PCIe interface circuit 260 includes a PCIe controller 262, a PIPE interface 264, a PHY TX block 266, a PHY RX block 270, and a clock generator 268. The PIPE interface 264 provides a parallel interface between the PCIe controller 262 and the PHY TX block 266 and the PHY RX block 270. The PCIe controller 262 (which may be implemented in hardware) may be configured to perform transaction layer, data link layer, and control flow functions.

The endpoint device system 250 also includes an oscillator (e.g., crystal oscillator) 272 configured to generate a stable reference clock signal 273 for the endpoint system memory 274 and the clock generator 268. In the example in FIG. 2, the clock generator 224 at the host system 210 is configured to generate a stable reference clock signal, which is forwarded to the endpoint device system 250 via a differential clock line 288 by the PHY RX block 226. At the endpoint device system 250, the PHY RX block 270 receives the endpoint (EP) reference clock signal on the differential clock line 288, and forwards the EP reference clock signal to the clock generator 268. The EP reference clock signal may have a frequency of 100MHz, but is not limited to such frequency. The clock generator 268 can be configured to generate multiple clock signals based on the EP reference clock signal from the differential clock line 288, as discussed further below. In this regard, the clock generator 268 may include multiple phase-locked loops (PLLs), in which each PLL generates a respective one of the multiple clock signals by multiplying up the frequency of the EP reference clock signal.

The system 205 can include a power management integrated circuit (PMIC) 290 coupled to a power supply 292 e.g., mains voltage, a battery, or other power source. The PMIC 290 is configured to convert the voltage of the power supply 292 into multiple supply voltages (e.g., using switch regulators, linear regulators, or any combination thereof). In this example, the PMIC 290 generates voltages 242 for the oscillator 230, voltages 244 for the PCIe controller 218, and voltages 246 for the PHY TX block 222, the PHY RX block 226, and the clock generator 224. The voltages 242, 244, and 246 may be programmable, in which the PMIC 290 is configured to set the voltage levels (corners) of the voltages 242, 244, and 246 according to instructions (e.g., from the host controller 212).

The PMIC 290 also generates a voltage 280 for the oscillator 272, a voltage 278 for the PCIe controller 262, and a voltage 276 for the PHY TX block 266, the PHY RX block 270, and the clock generator 268. The voltages 280, 278, and 276 may be programmable, in which the PMIC 290 is configured to set the voltage levels (corners) of the voltages 280, 278, and 276 according to instructions (e.g., from the device controller 252). The PMIC 290 may be implemented on one or more chips. Although the PMIC 290 is shown as one PMIC in FIG. 2, it is to be appreciated that the PMIC 290 may be implemented by two or more PMICs. For example, the PMIC 290 may include a first PMIC for generating voltages 242, 244, and 246 and a second PMIC for generating voltages 280, 278, and 276. In this example, the first and second PMICs may both be coupled to the same power supply 292 or to different power supplies.

In operation, the PCIe interface circuit 216 on the host system 210 may transmit data from the one or more host clients 214 to the endpoint device system 250 via the PCIe link 285. The data from the one or more host clients 214 may be directed to the PCIe interface circuit 216 according to a PCIe map set up by the host controller 212 during initial configuration, sometimes referred to as Link Initialization, when the host controller negotiates bandwidth for the link. At the PCIe interface circuit 216, the PCIe controller 218 may perform transaction layer and data link layer functions on the data e.g., packetizing the data, generating error correction codes to be transmitted with the data, etc.

The PCIe controller 218 outputs the processed data to the PHY TX block 222 via the PIPE interface 220. The processed data includes the data from the one or more host clients 214 as well as overhead data (e.g., packet header, error correction code, etc.). In one example, the clock generator 224 may generate a clock 234 for an appropriate data rate or transfer rate based on the reference clock signal 232, and input the clock 234 to the PCIe controller 218 to time operations of the PCIe controller 218. In this example, the PIPE interface 220 may include a 22-bit parallel bus that transfers 22-bits of data to the PHY TX block in parallel for each cycle of the clock 234. At 250MHz this translates to a transfer rate of approximately 8 GT/s.

The PHY TX block 222 serializes the parallel data from the PCIe controller 218 and drives the PCIe link 285 with the serialized data. In this regard, the PHY TX block 222 may include one or more serializers and one or more drivers. The clock generator 224 may generate a high-frequency clock for the one or more serializers based on the reference clock signal 232.

At the endpoint device system 250, the PHY RX block 270 receives the serialized data via the PCIe link 285, and deserializes the received data into parallel data. In this regard, the PHY RX block 270 may include one or more receivers and one or more deserializers. The clock generator 268 may generate a high-frequency clock for the one or more deserializers based on the EP reference clock signal. The PHY RX block 270 transfers the deserialized data to the PCIe controller 262 via the PIPE interface 264. The PCIe controller 262 may recover the data from the one or more host clients 214 from the deserialized data and forward the recovered data to the one or more device clients 254.

On the endpoint device system 250, the PCIe interface circuit 260 may transmit data from the one or more device clients 254 to the host system memory 240 via the PCIe link 285. In this regard, the PCIe controller 262 at the PCIe interface circuit 260 may perform transaction layer and data link layer functions on the data e.g., packetizing the data, generating error correction codes to be transmitted with the data, etc. The PCIe controller 262 outputs the processed data to the PHY TX block 266 via the PIPE interface 264. The processed data includes the data from the one or more device clients 254 as well as overhead data (e.g., packet header, sequence number, error correction code, etc.). An example of error correction code is cyclic redundancy check (CRC). In one example, the clock generator 268 may generate a clock based on the EP reference clock through a differential clock line 288, and input the clock to the PCIe controller 262 to control time operations of the PCIe controller 262.

The PHY TX block 266 serializes the parallel data from the PCIe controller 262 and drives the PCIe link 285 with the serialized data. In this regard, the PHY TX block 266 may include one or more serializers and one or more drivers. The clock generator 268 may generate a high-frequency clock for the one or more serializers based on the EP reference clock signal.

At the host system 210, the PHY RX block 226 receives the serialized data via the PCIe link 285, and deserializes the received data into parallel data. In this regard, the PHY RX block 226 may include one or more receivers and one or more deserializers. The clock generator 224 may generate a high-frequency clock for the one or more deserializers based on the reference clock signal 232. The PHY RX block 226 transfers the deserialized data to the PCIe controller 218 via the PIPE interface 220. The PCIe controller 218 may recover the data from the one or more device clients 254 from the deserialized data and forward the recovered data to the one or more host clients 214.

### PCIe Link Training and Status State Machine (LTSSM)

A PCIe link uses the Link Training and Status State Machine (LTSSM) to manage the process of establishing and maintaining the link between two PCIe devices (e.g., root complex and endpoint). The LTSSM is responsible for transitioning through various states to ensure that the PCIe link operates correctly and efficiently. LTSSM defines various link power management states, for example, an active (normal operational) state L0, a power saving state L0s, and a power standby state L1. L0s enables a PCIe link to quickly enter and recover from a power conservation state without going through Recovery. L1 is a power saving state that provides additional power saving over L0s at the cost of additional resume latency.

In some aspects, the PCIe link can have one or more L1 substates (L1ss) that enable the PCIe devices to further reduce power consumption when the PCIe link is in the standby state. L1ss provides finer control over the power usage by providing even lower power levels than the L1 state. In L1ss, certain system resources (e.g., voltage, clock frequency, etc.) can be adjusted to support a minimal link bandwidth to further save overall system power than that of L1. The PCIe link can exist the L1ss and go back to the active state L0 when normal data transmission resumes.

When the PCIe link enters the standby state (e.g., L1 state or L1ss), the device (e.g., host system 210 or endpoint device system 250 of FIG. 2) may transition to a lower power state to reduce overall power consumption. In some examples, the device can have multiple levels of low power states providing progressively more power saving. In some aspects, the transition to L1ss can involve reducing system resources (e.g., lowering the device’s rail voltage and clock frequency, reducing resources on system bus and/or memory, reducing voltage and/or clock frequency of system bus and/or memory, etc.) to correspond with the reduced power needs of the device when the PCIe link is in L1ss. This reduction in system resources (e.g., voltage and/or clock frequency) helps maximize power efficiency, ensuring that both the device and the PCIe link consume minimal power as needed. When the PCIe link exits the L1ss to resume activity, the device can increase the system resources (e.g., rail voltage and/or clock frequency) to support the increased performance level. However, frequent entries and exits of L1ss can lead to performance impacts of the system because the reducing/increasing available system resources (e.g., voltage, clock frequency) involve overhead. In some aspects, a PCIe device (e.g., host) can wait for a configurable timeout (e.g., L1 timeout) before reducing the system resources when the link is in L1ss, in order to balance power and/or performance of the system. For example, the device can start the L1 timeout period after the PCIe link enters the L1ss and waits for the L1 timeout to lapse before system resource is reduced or minimized. If a PCIe wakeup event occurs before the L1 timeout is lapsed, the PCIe link goes back to the active state L0. In PCIe, a wakeup event causes the PCIe link to transition from L1ss to the active state (e.g., L0) in response to a need for data transmission (e.g., incoming data packets) using the PCIe link. In the active state, the device can reactivate the link and associated circuitry for the active state. Efficient wakeup mechanisms are crucial for maintaining the balance between power efficiency and performance in a PCIe system.

Before the L1 timeout lapses, if a wakeup process is triggered, the device (e.g., PCIe host controller 212 of FIG. 2) can send a signal (e.g., an interrupt signal) to the processor (e.g., processor 102 of FIG. 1) to reconfigure the system resources (e.g., voltage, clock frequency, etc.) to enable the PCIe link to operate in that active state (e.g., L0) or a higher bandwidth state. In this case, the PCIe link can go back to the active state L0. Otherwise, after L1 timeout lapses, the device (e.g., PCIe host controller 212 of FIG. 2) can trigger an interrupt or send a signal to the processor (e.g., processor 102 of FIG. 1). In response to L1 timeout expiry, the processor can reduce the system resources when the PCIe link is in in the standby state. However, when the L1 timeout configured is longer than most wakeup intervals of the system, it can reduce potential power saving of L1ss because most wakeups do not happen within the timeout period, and the device will wait for an unnecessarily long time before reducing system resources.

Aspects of the disclosure provide a configurable standby state timeout that can be adjusted to balance between power consumption and performance across various use-cases after when a PCIe link transitions to a standby state. The timeout can be adjusted based on predicted link idle time after the PCIe link enters the standby state. For use cases that have long predicted link idle times after standby state entry, the configurable standby timeout can be short to start power saving early instead of delaying the timeout. To the contrary, for use cases that have short predicted link idle times, the configurable standby timeout can be programmed with the predicted link idle time plus a small offset. The small offset allows the expecting wakeup to occur within the configured timeout, and avoids minimizing system resources before timeout such that extra latencies in bringing back system resources can be avoided. If no wakeup occurs during the configured timeout period, system resource can be minimized to save power after the configured timeout.

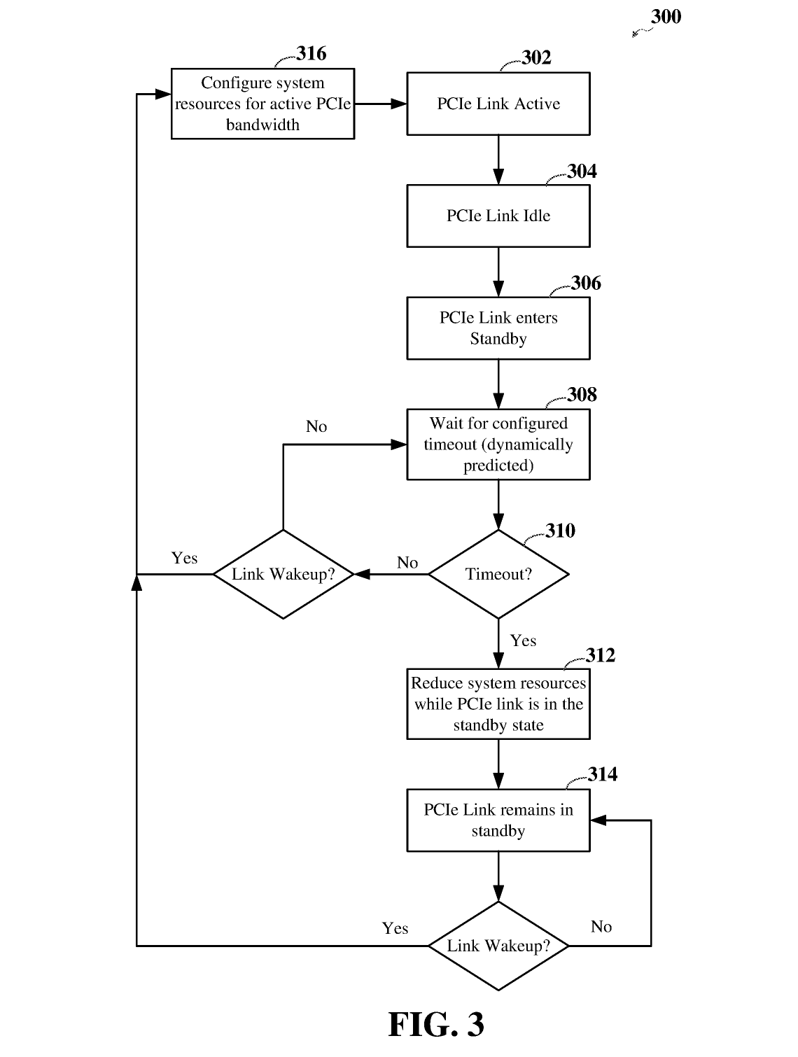

FIG. 3 is a diagram illustrating a process 300 of operating a wired data link between an active state and a standby state using a dynamically predicted link idle time according to some aspects of the disclosure. In some aspects, the process 300 can be performed using a PCIe link formed between two PCIe devices (e.g., a PCIe host, a PCIe endpoint) described above in relation to FIGS. 1 and 2. In other examples, the process 300 can be performed using other devices connected by a wired data link or PCIe link. The PCIe devices work together to ensure the data link is maintained, efficient, and able to support data transfer operations and configured bandwidths.

At 302, a PCIe link can be in an active state L0. In the active state, the data link is fully active, and data transmission can occur (in one or both directions) between connected devices. At 304, the PCIe link can enter an idle state in which no data transmission occurs between the connected devices. In the idle state, the data lanes of the PCIe link are not carrying any active data packets. The link is not being utilized for data transfers, but it can be maintained in an operational state. Even though no data is being transmitted, the electrical signals used to maintain the link (such as clock signals) can still be active. This ensures that the link can quickly transition to the active state when data transfer between connected devices is needed.

At 306, the PCIe link can enter a standby state (e.g., L1ss) after the link has been idle for a predetermined period of time. The time it takes for the PCIe link to enter the standby state after becoming idle can be referred to as the standby entry latency. This latency can vary depending on several factors, including the specific implementation of the connected devices, the version of PCIe being used, and power management settings configured by the system or the devices involved.

At 308, after entering the standby state, the PCIe link can wait for a timeout period (L1 timeout) to lapse. For example, the PCIe device can use a timer to measure the time lapsed after entering the standby state. In some aspects, the device (e.g., PCIe host, or endpoints) can dynamically determine the duration of the timeout period based on a predicted link idle time. For example, the configurable standby timeout can be short to start power saving early instead of delaying the timeout. To the contrary, for use cases that have short predicted link idle times, the configurable standby timeout can be programmed with the predicted link idle time plus a small offset. Therefore, the timeout duration is dynamically determined based on the predicted link idle time.

At 310, the device waits for the configured timeout to lapse. At 312, if the timeout is lapsed before any wakeup event is triggered, the device can reduce system resources while the link is in the standby state. In one example, the PCIe host controller can send a signal (e.g., interrupt) that triggers the device’s processor (e.g., processor 102 of FIG. 1) to determine the optimal system resources to support the device while the link is maintained in the standby state. Different components (e.g., CPU, GPU, NPU, memories, and other peripherals) of the device can collaborate to determine the system resources needed. For example, various components of the device (both hardware and software) can communicate to the processor their requirements for maintaining a certain level of performance or bandwidth. Based on the requirements, the device can determine the system resources (e.g., rail voltage and clock frequency) to meet the desired performance and bandwidth. For example, the device can reduce the voltage and/or clock frequency when the link is in the standby state after timeout. For example, a device component or peripheral (e.g., network interfaces, memory controller, etc.) can monitor its own activity and power requirements. If a device component anticipates needing to transmit or receive data soon, it may indicate (e.g., vote) for a certain bandwidth. The device (e.g., processor 102 of FIG. 1) can aggregate the votes from various hardware and/or software components and decide on the appropriate system resources needed.

At 314, the link remains in the standby state after the device reduces the system resources based on the needs of the various components of the device. At 316, if a link wakeup event occurs, the device can configure (e.g., increase) system resources (e.g., increase rail voltage and/or clock frequency) to support a higher link bandwidth. In one example, the PCIe host can send a signal (e.g., interrupt) that triggers the device’s processor (e.g., processor 102 of FIG. 1) to determine the system resources to support the higher link bandwidth. Different components (e.g., CPU, GPU, NPU, memories, and peripherals) of the device can collaborate to determine the system resources needed due to the wakeup event. For example, one or more components of the device (both hardware and software) can communicate their requirement for a higher level of performance or bandwidth. Based on the requirements, the device can determine the link bandwidth and the system resources (e.g., rail voltage and clock frequency) to meet the higher performance and bandwidth needed.

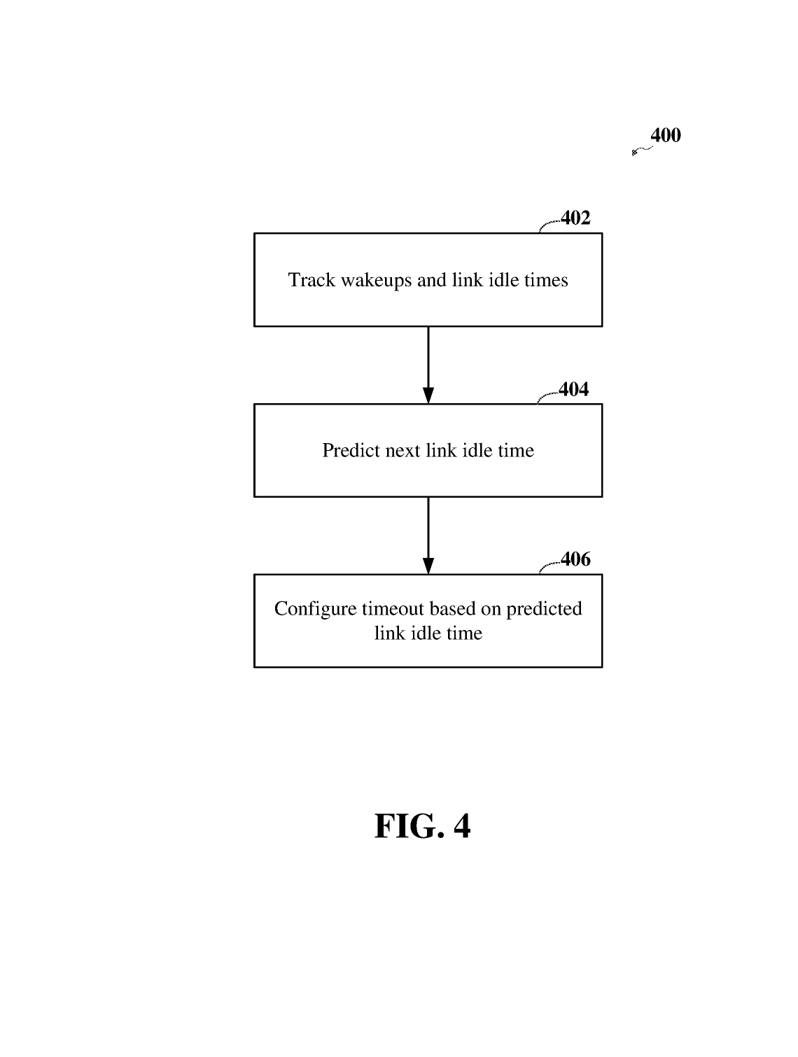

FIG. 4 is a flow chart illustrating a process 400 of configuring a standby timeout of a data link according to some aspects of the disclosure. In some aspects, a device (e.g., 102 processor or PCIe host 104 of FIG. 1) can perform the process 400 to configure a standby timeout (e.g., L1 timeout) described above in relation to FIG. 3. In one example, a device can use the standby timeout to determine when to start adjusting the system resources after the data link enters the standby state.

At 402, the device can keep track of the past wakeups and link idle times of a wired data link (e.g., a PCIe link). For example, every time a link wakeup occurs either before or after the L1 timeout lapses, the device can record the wakeup time and/or link idle interval. The link idle interval can be the duration between two consecutive link wakeups (e.g., a first link wakeup and a second link wakeup) of the data link. For example, the device (e.g. host controller 212 of FIG. 2) can maintain a record of the wakeups and/or link idle times in a memory or storage (e.g., system memory 240).

At 404, the device can predict the next link idle time based on the history of wakeups and/or link idle times. For example, the device, based on the data collected (e.g., past wakeup times and link idle times), can use various methods to predict the next link idle time. In some aspects, the device can use the last few link idle times (samples) to predict the next link idle time. In one example, the device can use the average of the last few link idle times (e.g., 2 or more previous link idle times) as the next link idle time. In one example, the deviation between the samples needs to be less than a predetermined value before the device can use the average of the samples as the next link idle time. For example, when the deviation between the past link idle times is greater than a predetermined threshold, the device can use other methods to predict the next link idle time. For example, the device can use the last link idle time as the predicted link idle time.

At 406, the device can configure the L1 timeout based on the predicted link idle time. For example, if the predicted link idle time is greater than a first predetermined value (e.g., a value corresponding to a long idle time), the device can configure the L1 timeout to a minimum value (less than the first predetermined value) so that the device can reduce the system resources earlier or immediately rather than waiting for the L1 timeout to lapse. On the contrary, if the predicted link idle time is less than a predetermined value (e.g., a static value less than the first predetermined value) that indicates a possible wakeup event to occur soon or imminently, the device can configure the L1 timeout as the predicted link idle time plus an offset (e.g., a non-zero offset). With the offset, the device can avoid the overhead of reducing system resources before the wakeup event.

In some aspects, a device (e.g., a PCIe controller 218 of FIG. 2) after observing the link to be inactive, can trigger the transition from the active state (e.g., L0) to the standby state (e.g., L1ss). After entering the standby state, the device waits for the dynamically configured L1 timeout, which is based on the predicted link idle time, to lapse. If a link wakeup event occurs before the L1 timeout expires, the link transitions back to the active state. If no link wakeup event occurs before the L1 timeout, the device can reduce the system resources while the device is in the standby state after the L1 timeout. While the link is in standby state, if a wakeup event occurs, the device can increase the system resources to support a higher link bandwidth and transition the link back to the active state.

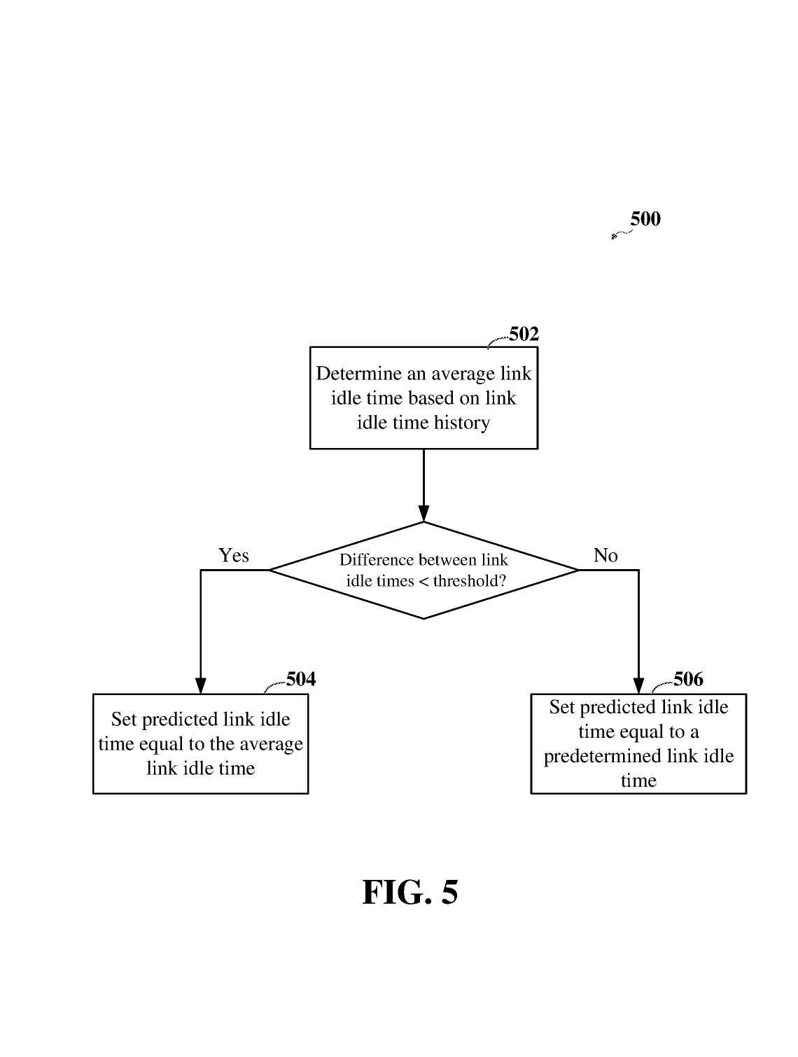

FIG. 5 is a flow chart illustrating a process 500 of predicting a link idle time of a data link according to some aspects of the disclosure. In some aspects, a device (e.g., a host controller 212 of FIG. 2) can use the process 500 to predict the next link idle time of a data link (e.g., PCIe link) used in the process described above in relation to FIG. 4. At 502, the device can determine an average link idle time based on link idle time history maintained at the device. In one example, the device can keep a history of the last two or more link idle times. In one example, the device can keep a history of the last two or more link wakeup times and determine the link idle time as a time duration between two link wakeups. At 504, if the difference between the past link idle times is less than a predetermined threshold, the device can set the predicted link idle time equal to the average link idle time. At 506, if the difference between past link idle times is not less than the predetermined threshold, the device can set the predicted link idle time equal to a predetermined link idle time, for example, the last link idle time.

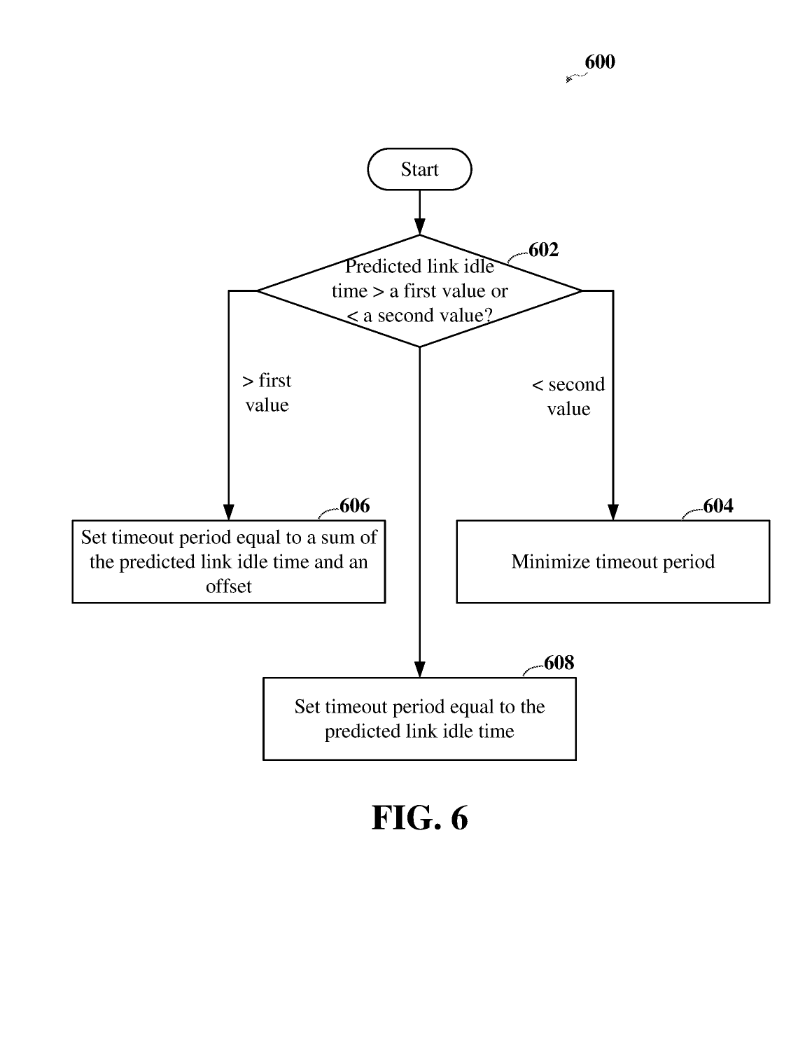

FIG. 6 is a flow chart illustrating a process 600 of configuring a timeout period based on a predicted link idle time according to some aspects of the disclosure. In some aspects, a device (e.g., a host controller 212 of FIG. 2) can use the process 600 to determine the timeout period used in the process 400 of FIG. 4 based on a predicted link idle time. In some aspect, the device can be a PCIe device.

At 602, the device can determine whether the predicted link idle time is greater than a first value or less than a second value. In one example, the device can determine the predicted idle time using the process 500 of FIG. 5 described above. For example, the first value is a sufficiently large value corresponding to a long link idle time. At 604, when the predicted link idle time is greater than the first value, the device can minimize the timeout period so that the device can reduce or minimize system resources (e.g., rail voltage and frequency) earlier rather than waiting for the timeout period to lapse. At 606, when the predicted link idle time is less than the second value, the device can set the link timeout period equal to a sum of the predicted link idle time and an offset. With the offset, the device can avoid the overhead involved to reconfigure the system resources due to entering and existing the standby state. For example, the second value is a value indicating that a link wakeup event is going to occur soon or imminent. Otherwise, at 608, the device can set the timeout period equal to the predicted link idle time. In some examples, the first value and the second can be the same value (e.g., 20 milliseconds).

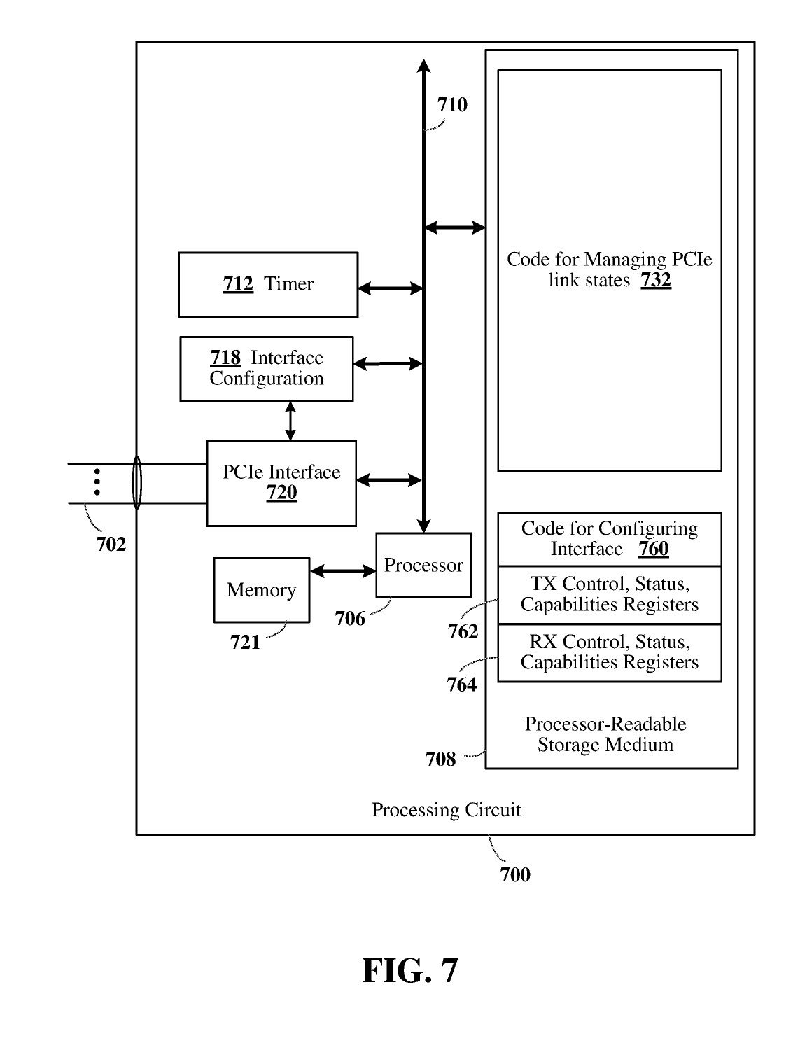

FIG. 7 is a block diagram of a link interface processing circuit 700 according to some aspects of the disclosure. The link interface processing circuit 700 may be a part of a host or an endpoint. It is coupled to a link 702, e.g., a PCIe link, with multiple duplex lanes similar to those described in relation to FIGS. 1-2. The link 702 can be coupled at an opposite end to another PCIe device (e.g., an endpoint or a host). Data and control information communicated as packets through the link 702 are coupled to a link interface 720 (e.g., PCIe interface) which provides a PHY level interface to the link 702 and converts baseband signals to packets. The data and control packets are sent through the link interface 720 through a bus 710 to other components of the processing circuit 700. The link interface 720 has a direct connection to interface configuration circuitry 718 for configuration and control settings for the operation of the link 702.

The processing circuit 700 further includes a memory 721 that can be used for storing data and information used by a processor 706 during various operation. In some aspects, the memory 721 can store information and data packets used for flow control of PCIe traffic and transitions between link states (e.g. L0 and L1ss). In one example, the memory 721 can store a history of past link wakeups and link idle times.

The processing circuit 700 further includes timer circuitry 712 (e.g., a timer) that is coupled to the bus 710. The timer circuitry 712 can be configured for various timing-related functions, for example, a standby timeout, wakeups and idle time tracking, etc. The processor 706 and timer circuitry 712 can access a computer-readable storage medium 708 to access code for managing PCIe link states 732 and transitions between link states. In some aspects, the storage medium is a non-transitory computer-readable medium.

The interface configuration circuitry 718 is coupled to the bus 710 as is the timer circuitry 712 so that each of these blocks may communicate with each other, with the storage medium 708 and to the processor 706. The processor 706 can control the operation of the other components and instigates instances of each component or its function as appropriate to the operation of the processing circuit 700. The interface configuration circuitry 718 also has access to code for configuring the PCIe interface 760. On executing this code, the interface configuration circuitry 718 can read and write values from a variety of configuration registers. For example, these registers include TX control, status, and capabilities registers 762 and RX control, status, and capabilities registers 764. These registers may be accessed and read at the start of link initialization and then updated with the result of the initialization. The registers may also be modified in response to power management and bandwidth negotiations or to change link state (e.g., L0 and L1ss) of the link 702.

The processing circuit 700 may initialize the link 702, manage the voltage, frequency, bandwidth, and link state of the link 702. In operation, bandwidth requests may also be received from the host or endpoint. Bandwidth requests may cause a bandwidth negotiation followed by a change in values set to control, status, and capabilities registers. The number of active lines may then be changed in response to transmit traffic activity and receive traffic activity.

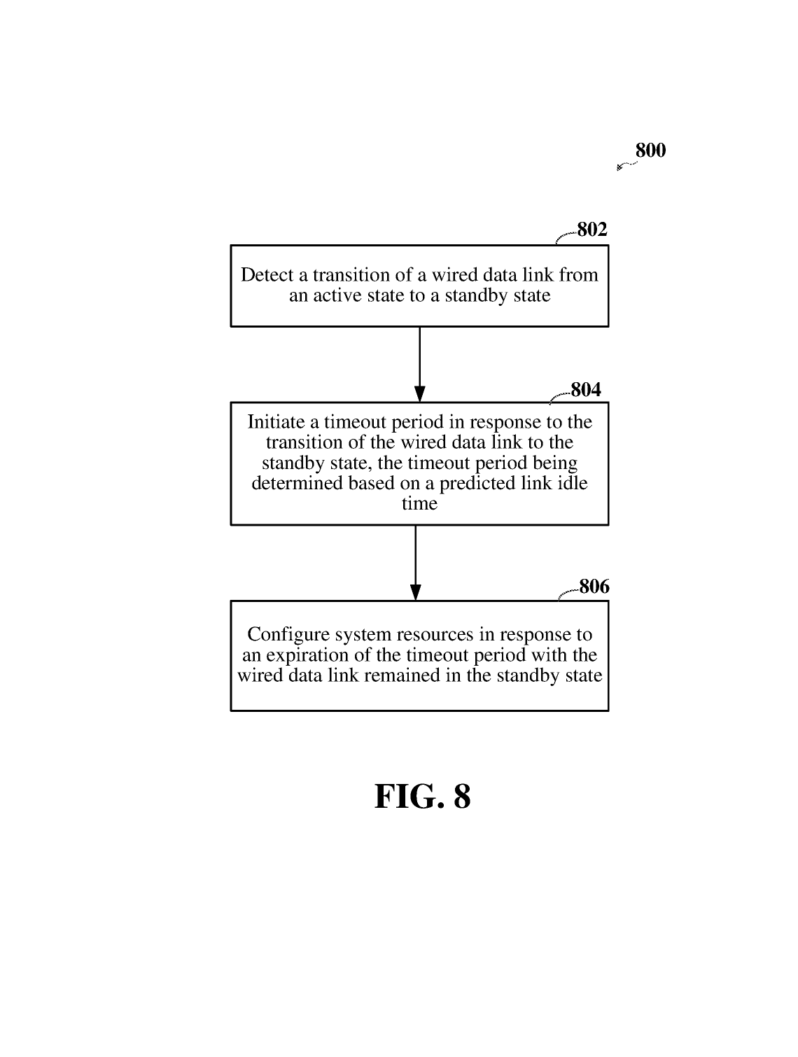

FIG. 8 illustrates a flow diagram of a method 800 for controlling system resources based on a predicted link idle time of a wired data link according to some aspects of the present disclosure. In certain aspects, the method 800 provides techniques for controlling system resources at an apparatus (e.g., SoC) with a PCIe link in a standby state (e.g., L1ss) based on predicted link idle time. As described herein the wired data link can be a PCIe link, however, the method may be adapted to suit other wired and wireless data links using a standby state.

At 802, the method includes a process of detecting a transition of the wired data link from an active state to a standby state. For example, the wired data link can be the PCIe link 702 of FIG. 7 that transitions from an active state (e.g., L0) to a standby state (e.g., L1ss). In one example, the PCIe Interface 720 of FIG. 7 can provide a means to detect the state transition of the PCIe link. When the PCIe controller 218 detects that the link is not actively transmitting data (idle), the wired data link can transition to the standby state and enters a standby state that uses less power than the active state. For example, if the PCIe controller detects no data transactions (e.g., reads, writes) occurring over a certain period, the PCIe link may be considered idle (not active). In the standby state, the device can power down or turn off certain components (e.g., transmitters and receivers) of the PCIe interface circuit.

At 804, the method includes a process of initiating a timeout period in response to the transition of the wired data link to the standby state. The process can determine the timeout period based on a predicted link idle time. In one example, a timer (e.g., timer 712 of FIG. 7) and a processor (e.g., processor 706 of FIG. 7) of a PCIe interface processing circuit can provide a means to initiate the timeout period. The process can determine the predicted link idle time based on a history of past link wakeup times and/or link idle times. In one example, a PCIe interface processing circuit can determine the predicted link idle time using the processes described above in relation to FIGS. 4 and 5. After entering the standby state, the processing circuit can initiate a L1 timeout period as described in relation to FIG. 3 for a PCIe link after the link enters the standby state (e.g., L1ss). The processing circuit can use a timer (e.g., timer 712 of FIG. 7) to measure the time lapsed after initiating the timeout period. In the standby state, the device and the data link have lower system resources requirement because the data link does not have data traffic in the standby state. However, before the timeout period is lapsed, the device does not reduce system resources even when the data link is in the standby state. The timeout period enables the device to avoid the overhead of frequent and/or unnecessary resource reconfiguration due to link wakeup events that can occur before the timeout period is lapsed.

At 806, the method includes a process of configuring system resources in response to an expiration of the timeout period with the wired data link remained in the standby state (e.g., L1ss). In some aspects, the apparatus can reduce the system resources (e.g., voltage rail, clock frequency) when the wired data link is in the standby state after the timeout period. Lowering the voltage rail and/or clock frequency can reduce the power consumption of the apparatus. For example, after the timeout period is lapsed (expired), the PCIe interface 720 of FIG. 7 can send a signal (e.g., interrupt) to the processor of the device to trigger a process of determining the system resources needed by the apparatus when the PCIe link is in the standby state. For example, the processor 706 of FIG. 7 and/or the processor 102 of FIG. 1 can provide a means to configure system resources. For example, the processor can lower the voltage rail and/or clock frequency to reduce the power consumption of the device when the PCIe link is in the standby state.

The following provides an overview of examples of the present disclosure.

Example 1: An apparatus for data communication, comprising: an interface circuit configured to provide an interface with a wired data link connected with a link partner; and a controller configured to: detect a transition of the wired data link from an active state to a standby state; initiate a timeout period in response to the transition of the wired data link to the standby state, the timeout period being determined based on a predicted link idle time of the wired data link; and configure system resources in response to an expiration of the timeout period with the wired data link remained in the standby state.

Example 2: The apparatus of example 1, wherein the controller is further configured to: track at least one of a wakeup time or a link idle time of the wired data link; determine the predicted link idle time based on at least one of the wakeup time or the link idle time; and determine a duration of the timeout period based on the predicted link idle time.

Example 3: The apparatus of example 1 or 2, wherein the controller is further configured to: in response to the predicted link idle time being greater than a first predetermined value, minimize the timeout period; and in response to the predicted link idle time being less than a second predetermined value that is less than the first predetermined value, set the timeout period equal to a sum of the predicted link idle time plus an offset.

Example 4. The apparatus of example 1, wherein the controller is further configured to: determine an average link idle time of a plurality of link idle times tracked by the apparatus; and set the predicted link idle time based on the average link idle time.

Example 5: The apparatus of example 4, wherein the controller is further configured to: determine the plurality of link idle times based on a plurality of past link wakeup times.

Example 6: The apparatus of example 1, 2, 4, or 5, wherein the controller is further configured to configure the system resources by adjusting at least one of a clock frequency or a voltage of the apparatus to support a bandwidth of the wired data link in the standby state.

Example 7: The apparatus of example 1, 2, or 4, wherein the controller is further configured to: detect a first transition of the wired data link from the active state to the standby state; initiate a first timeout period in response to the first transition of the wired data link to the standby state; detect a second transition of the wired data link from the active state to the standby state; and initiate a second timeout period in response to the second transition of the wired data link to the standby state, the first timeout period and the second timeout period being different in duration.

Example 8: A method of data communication at an apparatus, comprising: detecting a transition of a wired data link from an active state to a standby state; initiating a timeout period in response to the transition of the wired data link to the standby state, the timeout period being determined based on a predicted link idle time of the wired data link; and configuring system resources in response to an expiration of the timeout period with the wired data link remained in the standby state.

Example 9: The method of example 8, further comprising: tracking at least one of a wakeup time or a link idle time of the wired data link; determining the predicted link idle time based on at least one of the wakeup time or the link idle time; and determining a duration of the timeout period based on the predicted link idle time.

Example 10: The method of example 8 or 9, further comprising: in response to the predicted link idle time being greater than a first predetermined value, minimizing the timeout period; and in response to the predicted link idle time being less than a second predetermined value that is less than the first predetermined value, setting the timeout period equal to a sum of the predicted link idle time plus an offset.

Example 11: The method of example 8, further comprising: determining an average link idle time of a plurality of link idle times tracked by the apparatus; and setting the predicted link idle time based on the average link idle time.

Example 12: The method of example 11, further comprising: determining the plurality of link idle times based on a plurality of past link wakeup times.

Example 13: The method of example 8, 9, 11, or 12, further comprising: configuring the system resources by adjusting at least one of a clock frequency or a voltage of the apparatus to support a bandwidth of the wired data link in the standby state.

Example 14: The method of example 8, 9, or 11, further comprising: detecting a first transition of the wired data link from the active state to the standby state; initiating a first timeout period in response to the first transition of the wired data link to the standby state; detecting a second transition of the wired data link from the active state to the standby state; and initiating a second timeout period in response to the second transition of the wired data link to the standby state, the first timeout period and the second timeout period being different in duration.

Example 15: An apparatus for data communication, comprising: means for detecting a transition of a wired data link from an active state to a standby state; means for initiating a timeout period in response to the transition of the wired data link to the standby state, the timeout period being determined based on a predicted link idle time of the wired data link; and means for configuring system resources in response to an expiration of the timeout period with the wired data link remained in the standby state.

Example 16: The apparatus of example 15, further comprising: means for tracking at least one of a wakeup time or a link idle time of the wired data link; means for determining the predicted link idle time based on at least one of the wakeup time or the link idle time; and means for determining a duration of the timeout period based on the predicted link idle time.

Example 17: The apparatus of example 15 or 16, further comprising: means for, in response to the predicted link idle time being greater than a first predetermined value, minimizing the timeout period; and means for, in response to the predicted link idle time being less than a second predetermined value that is less than the first predetermined value, setting the timeout period equal to a sum of the predicted link idle time plus an offset.

Example 18: The apparatus of example 15, further comprising: means for determining an average link idle time of a plurality of link idle times tracked by the apparatus; and means for setting the predicted link idle time based on the average link idle time.

Example 19: The apparatus of example 18, further comprising: means for determining the plurality of link idle times based on a plurality of past link wakeup times.

Example 20: The apparatus of example 15, 16, or 18, further comprising: means for configuring the system resources by adjusting at least one of a clock frequency or a voltage of the apparatus to support a bandwidth of the wired data link in the standby state.

It is to be appreciated that the present disclosure is not limited to the exemplary terms used above to describe aspects of the present disclosure. For example, bandwidth may also be referred to as throughput, data rate or another term.

Although aspects of the present disclosure are discussed above using the example of the PCIe standard, it is to be appreciated that present disclosure is not limited to this example, and may be used with other standards.

The host clients 214, the host controller 212, the device controller 252 and the device clients 254 discussed above may each be implemented with a controller or processor configured to perform the functions described herein by executing software including code for performing the functions. The software may be stored on a non-transitory computer-readable storage medium, e.g. a RAM, a ROM, an EEPROM, an optical disk, and/or a magnetic disk, shows as host system memory 240, endpoint system memory 274, or as another memory.

Any reference to an element herein using a designation e.g. “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect electrical or other communicative coupling between two structures. Also, the term “approximately” means within ten percent of the stated value.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An apparatus for data communication, comprising:
an interface circuit configured to provide an interface with a wired data link connected with a link partner; and
a controller configured to:
detect a transition of the wired data link from an active state to a standby state;
initiate a timeout period in response to the transition of the wired data link to the standby state, the timeout period being determined based on a predicted link idle time of the wired data link; and
configure system resources in response to an expiration of the timeout period with the wired data link remained in the standby state.

2. The apparatus of claim 1, wherein the controller is further configured to:
track at least one of a wakeup time or a link idle time of the wired data link;
determine the predicted link idle time based on at least one of the wakeup time or the link idle time; and
determine a duration of the timeout period based on the predicted link idle time.

3. The apparatus of claim 1, wherein the controller is further configured to:
in response to the predicted link idle time being greater than a first predetermined value, minimize the timeout period; and
in response to the predicted link idle time being less than a second predetermined value that is less than the first predetermined value, set the timeout period equal to a sum of the predicted link idle time plus an offset.

4. The apparatus of claim 1, wherein the controller is further configured to:
determine an average link idle time of a plurality of link idle times tracked by the apparatus; and
set the predicted link idle time based on the average link idle time.

5. The apparatus of claim 4, wherein the controller is further configured to:
determine the plurality of link idle times based on a plurality of past link wakeup times.

6. The apparatus of claim 1, wherein the controller is further configured to configure the system resources by adjusting at least one of a clock frequency or a voltage of the apparatus to support a bandwidth of the wired data link in the standby state.

7. The apparatus of claim 1, wherein the controller is further configured to:
detect a first transition of the wired data link from the active state to the standby state;
initiate a first timeout period in response to the first transition of the wired data link to the standby state;
detect a second transition of the wired data link from the active state to the standby state; and
initiate a second timeout period in response to the second transition of the wired data link to the standby state, the first timeout period and the second timeout period being different in duration.

8. A method of data communication at an apparatus, comprising:
detecting a transition of a wired data link from an active state to a standby state;
initiating a timeout period in response to the transition of the wired data link to the standby state, the timeout period being determined based on a predicted link idle time of the wired data link; and
configuring system resources in response to an expiration of the timeout period with the wired data link remained in the standby state.

9. The method of claim 8, further comprising:
tracking at least one of a wakeup time or a link idle time of the wired data link;
determining the predicted link idle time based on at least one of the wakeup time or the link idle time; and
determining a duration of the timeout period based on the predicted link idle time.

10. The method of claim 8, further comprising:
in response to the predicted link idle time being greater than a first predetermined value, minimizing the timeout period; and
in response to the predicted link idle time being less than a second predetermined value that is less than the first predetermined value, setting the timeout period equal to a sum of the predicted link idle time plus an offset.

11. The method of claim 8, further comprising:
determining an average link idle time of a plurality of link idle times tracked by the apparatus; and
setting the predicted link idle time based on the average link idle time.

12. The method of claim 11, further comprising:
determining the plurality of link idle times based on a plurality of past link wakeup times.

13. The method of claim 8, further comprising:
configuring the system resources by adjusting at least one of a clock frequency or a voltage of the apparatus to support a bandwidth of the wired data link in the standby state.

14. The method of claim 8, further comprising:
detecting a first transition of the wired data link from the active state to the standby state;
initiating a first timeout period in response to the first transition of the wired data link to the standby state;
detecting a second transition of the wired data link from the active state to the standby state; and
initiating a second timeout period in response to the second transition of the wired data link to the standby state, the first timeout period and the second timeout period being different in duration.

15. An apparatus for data communication, comprising:
means for detecting a transition of a wired data link from an active state to a standby state;
means for initiating a timeout period in response to the transition of the wired data link to the standby state, the timeout period being determined based on a predicted link idle time of the wired data link; and
means for configuring system resources in response to an expiration of the timeout period with the wired data link remained in the standby state.

16. The apparatus of claim 15, further comprising:
means for tracking at least one of a wakeup time or a link idle time of the wired data link;
means for determining the predicted link idle time based on at least one of the wakeup time or the link idle time; and
means for determining a duration of the timeout period based on the predicted link idle time.

17. The apparatus of claim 15, further comprising:
means for, in response to the predicted link idle time being greater than a first predetermined value, minimizing the timeout period; and
means for, in response to the predicted link idle time being less than a second predetermined value that is less than the first predetermined value, setting the timeout period equal to a sum of the predicted link idle time plus an offset.

18. The apparatus of claim 15, further comprising:
means for determining an average link idle time of a plurality of link idle times tracked by the apparatus; and
means for setting the predicted link idle time based on the average link idle time.

19. The apparatus of claim 18, further comprising:
means for determining the plurality of link idle times based on a plurality of past link wakeup times.

20. The apparatus of claim 15, further comprising:
means for configuring the system resources by adjusting at least one of a clock frequency or a voltage of the apparatus to support a bandwidth of the wired data link in the standby state.
